(19) United States
(12) Patent Application Publication
(10) Pub. No.: US 2015/0034166 A1
(43) Pub. Date: Feb. 5, 2015

(54) WASTE EVACUATION SYSTEM FOR A VEHICLE

(71) Applicant: LIPPERT COMPONENTS MANUFACTURING, INC., Elkhart, IN (US)

(72) Inventor: Douglas R. SWARTS, Hollister, CA (US)

(21) Appl. No.: 14/447,210

(22) Filed: Jul. 30, 2014

Related U.S. Application Data
(60) Provisional application No. 61/860,002, filed on Jul. 30, 2013.
(60) Provisional application No. 61/899,845, filed on Nov. 4, 2013.

(51) Int. Cl. B60R 15/00

(52) U.S. Cl. CPC B60R 15/00
USPC 137/1; 137/351

(57) ABSTRACT

A waste evacuation system for a vehicle includes an enclosure defining a fixed aperture and a selectively openable and closable access panel. A hose having a first end and a second end extends through the fixed aperture. The first end of the hose may be connected to a waste water tank disposed on a vehicle. The second end of the hose is connected to a nozzle. The nozzle and the second end of the hose can be stored in the enclosure with the access panel in a closed position. With the access panel opened, the nozzle and the second end of the hose may be removed and the nozzle may be connected to a sewer inlet connection.

### CROSS-REFERENCE TO RELATED APPLICATIONS

This application claims benefit under 35 U.S.C. §119 of the filing dates of U.S. Provisional Patent Application Nos. 61/860,002, filed on Jul. 30, 2013, and 61/899,845, filed on Nov. 4, 2013, and incorporates by reference the disclosures thereof in their entireties.

### BACKGROUND AND SUMMARY

A recreational vehicle (“RV”) may include an on-board water supply providing water to sinks, showers, toilets and/or other fixtures, and a waste water tank or tanks (references herein to a tank in the singular may include tanks in the plural and vice versa, unless context dictates otherwise) for collecting waste water from those fixtures. The waste water tank may include a drain that can be connected to a ground sewer inlet of a waste water or sewage receptacle at an RV park or other facility. This connection typically is made by temporarily connecting a hose to an outlet of the waste water tank, running the hose from the waste water tank to the sewer inlet, and opening a drain valve near the tank to enable flow of effluent from the tank to the sewer inlet. Once the tank has been drained, the hose typically is disconnected from the waste water tank and the sewer inlet and stored in a compartment of the RV.

### BRIEF DESCRIPTION OF THE DRAWINGS

FIG. 1 is a side view of an RV having a frame and a waste water tank mounted on the frame and an enclosure containing a hose and nozzle mounted under the frame;

FIG. 2 is a perspective view of the enclosure of FIG. 1 having an access panel in a closed position;

FIG. 3 is an end elevation view of the enclosure of FIG. 1 having an access panel in an open position;

FIG. 4 is an end elevation view of the enclosure of FIG. 1 having an access panel in an open position;

FIG. 5 is a side view of the enclosure of FIG. 1 and a hose and nozzle extending therefrom;

FIGS. 6A and 6B are top and end views, respectively, of a top panel of the enclosure of FIG. 1;

FIGS. 7A and 7B are top and end views, respectively, of a bottom panel of the enclosure of FIG. 1;

FIGS. 8A and 8B are side elevation views of embodiments of the enclosure of FIG. 1 having access panels in an open position;

FIG. 9 is a side elevation view of an alternate embodiment of the enclosure of FIG. 1 having an access panel in an open position; and

FIG. 10 is a side elevation view of another alternate embodiment of the enclosure of FIG. 1 having an access panel in an open position.

### DETAILED DESCRIPTION OF THE DRAWINGS

The drawings show illustrative embodiments of a waste evacuation system 20 for a vehicle 22, for example, a motor home or other type of recreational vehicle (“RV”). The system 20 may include an enclosure 24 configured for attachment to the vehicle 22, a drain hose 26 that may be stored in the enclosure and may be at least partially removed from the enclosure when in use, and a nozzle 28. The system 20 may be used to drain effluent from a waste water tank 30 that may be located on the vehicle 22 to an inlet of a sewage system (not shown), as may be found in an RV park or other facility configured to receive such effluent. The system typically would be located proximate and/or be accessible from the driver's side of the vehicle but could be located elsewhere.

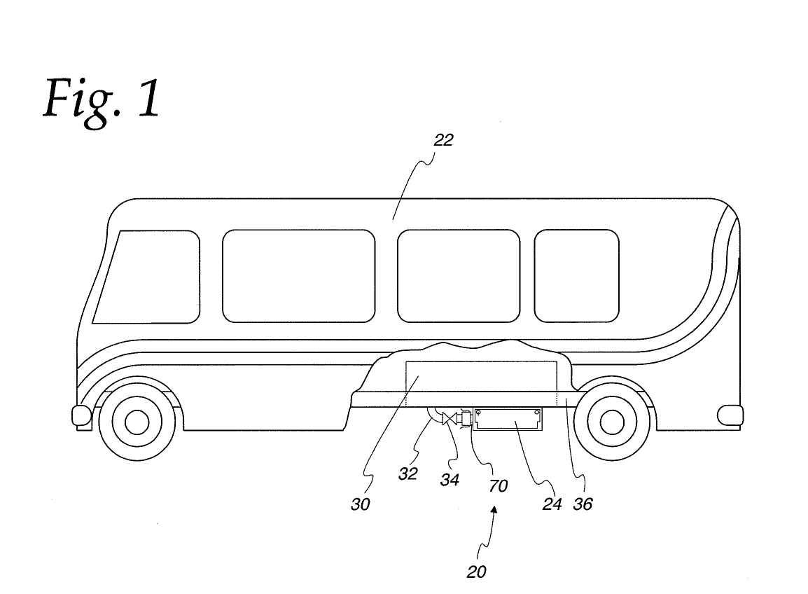

As shown in FIG. 1, the enclosure 22 may be mounted underneath a frame 36 of the vehicle 22. In the illustrated embodiment, the frame 36 comprises one or more I-beams running fore and aft along the length of the vehicle, and the enclosure 22 is mounted to the underside of the I-beam(s). In another embodiment, the enclosure 22 could be mounted next to the I-beams. In further embodiments, the frame could be configured in other ways, and the enclosure 22 could be mounted below the frame, above the frame, next to the frame, or integrated with the frame.

The enclosure 22 may include a top wall 38, a bottom wall 40 opposite the top wall, and a side wall 42 between and connecting the top wall and the bottom wall. The foregoing walls define an interior 44 of the enclosure and separate the interior of the enclosure from an exterior of the enclosure, that is, the space surrounding the enclosure.

Any or all of the top wall 38, bottom wall 40, and side wall 42 may comprise or define one or more panels. For example, each of top wall 38 and/or bottom wall 40 could comprise a single planar or curved panel or it could comprise plural planar or curved panels. The curved panels could comprise simple or complex curves. Likewise, the side wall 42 could comprise a single, continuous panel or a plurality of discontinuous panels. For example, the side wall 42 could comprise a front end panel 42A, a rear end panel 42B, a left side panel 42C and a right side panel 42D. (Terms such as “front” and “left” indicating direction and/or orientation are used herein for reference and should not be construed as absolute unless context dictates otherwise.)

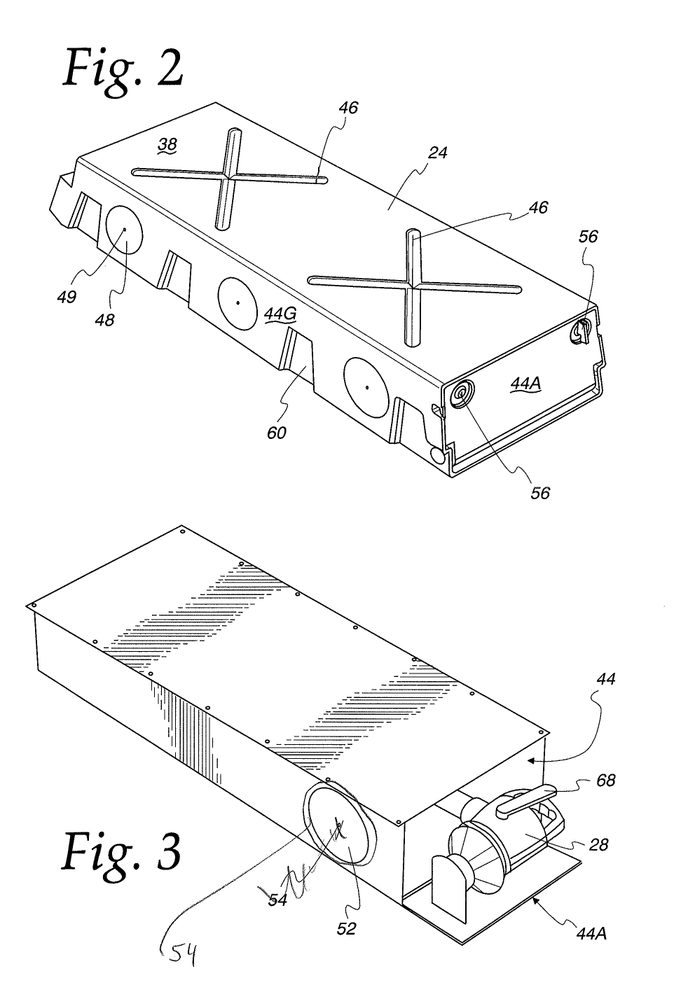

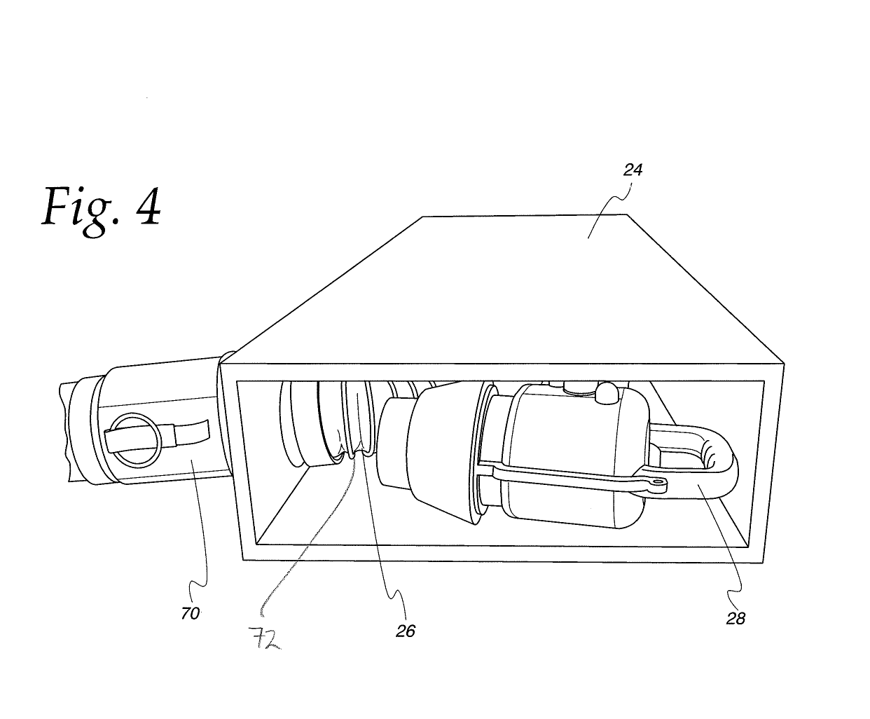

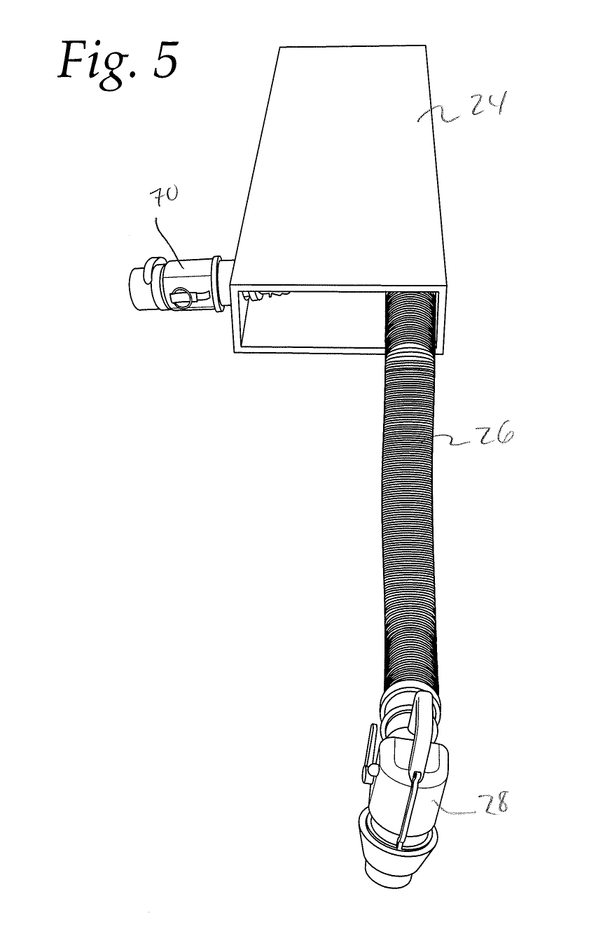

Any of the foregoing panels may include surface contours, for example, ribs, blisters, depressions, reliefs, and the like. The surface contours could be integrally molded with the panel, formed into the panels by stamping or another suitable process, or by provided in the form of additional structure placed upon or attached to the panels using adhesives, mechanical fasteners, or other means. Such surface contours may be provided for structural, functional and/or decorative purposes. For example, the embodiment shown in FIG. 2 includes stiffeners 46 in the top wall 38, bracket-receiving pockets 48 in the side wall 42, cut-out blanks 48 in the side wall, and a logo 50 in the side wall 42, as will be discussed further below.

One of the walls 38, 40, 42 may define an aperture 52 configured and sized to receive a portion of the hose 26, as will be discussed further below, thereby enabling the portion of the hose to extend from the interior 44 to the exterior of the enclosure. The drawings generally show the left side panel 42C of the sidewall 42 defining the aperture 52. In other embodiments, the aperture 52 could be defined by any of the other panels 42i of the sidewall 42 or in the top wall 38 or bottom wall 40. The location of the aperture 52 may be selected as desired for a particular application and may be influenced by the location of the waste water tank 30 with respect to the enclosure 24 on the vehicle 22. A grommet 54 may be provided at the aperture 52 to preclude abrasion or other damage to the hose that might result from direct contact of the hose with the exposed edge of aperture 52. The grommet 54 also can function as a seal to preclude entry of dust, dirt, water, etc., from entering the enclosure 24 through the aperture 52. Alternatively or additionally a stress relief may be provided to retain the hose 26 to the enclosure 24 proximate the aperture 52.

The enclosure 24 may include an access panel defining an opening providing access from the exterior to the interior of the enclosure. The access panel could comprise the entirety or a portion of top wall 38, bottom wall 40 or side wall 42 of the enclosure 24. For example, as shown in FIGS. 2 and 3, the access panel could be embodied as the front end panel 42A of the sidewall 42 of the enclosure 22. In this embodiment, the front end panel 42A includes pins projecting outwardly from the lower left and right ends thereof, which pins rotatably engage with corresponding apertures or surface depressions in left and right panels 42C, 42D of side wall 42. As such, the front end panel 42A may be rotated outwardly and downwardly from a pivot point proximate bottom wall 40 of the enclosure between open and closed positions. In other embodiments, the access panel could be hinged from another panel or wall by any suitable form of hinge, for example, a living hinge, a piano hinge, a pin-type hinge, or one or more conventional hinges, or the like. For example, the access panel could be hinged from an upper portion of the enclosure 24 so that the access panel opens outwardly and upwardly. In further embodiments, the access panel could be removable from the enclosure 24. Locking and/or conventional latches 56 may be provided to selectively secure the access panel to the enclosure 24 in the closed position.

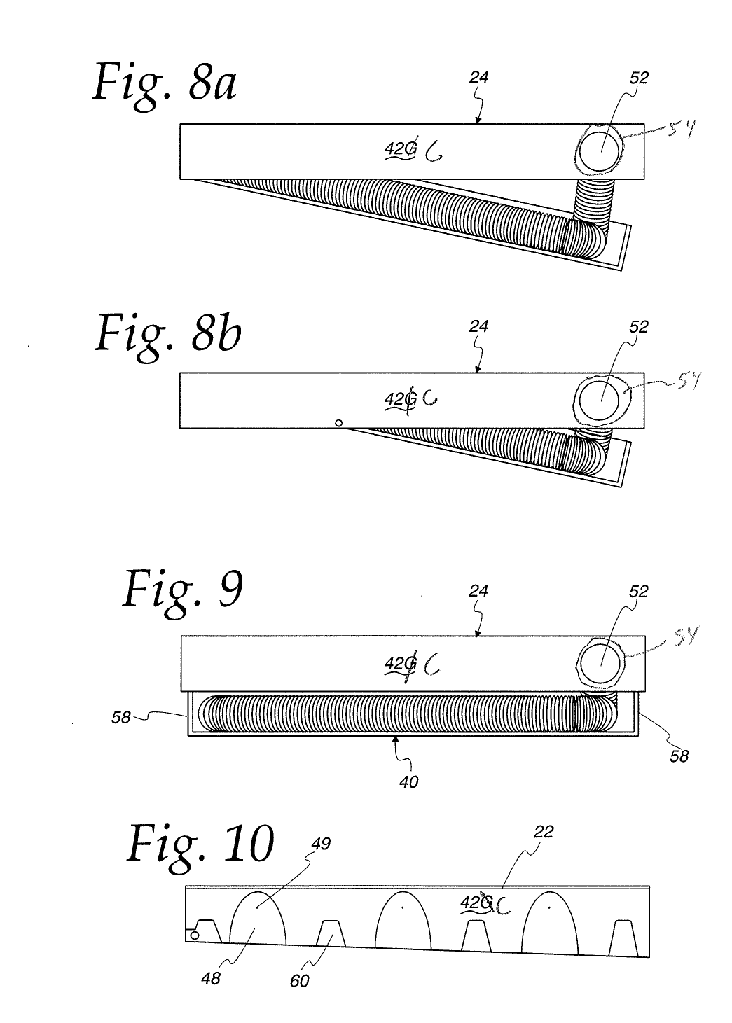

Alternatively, as shown in FIG. 8A, the access panel could be the entirety of the bottom wall 40, and it could further include a portion, or the entirety, of the front wall 42. In this embodiment, the access panel could be hinged from the rear of the enclosure 24, for example, from the rear end panel 42B of the enclosure or from rear portions of the left and right side panels 42C, 42D of the enclosure 24. As such, the front portion of the access panel may be lowered from the sidewall of the enclosure to provide access to the interior thereof. In another embodiment, as shown in FIG. 8B, the access panel could be a portion of the bottom wall 40, and the rest or at least another portion of the bottom wall could be fixed. For example, a rear portion of the bottom wall 40 could be attached to rear end panel 42B and rear portions of left and right panels 42C, 42D of the side wall 42. A forward portion of the bottom wall 40 could be hinged from enclosure 24 in a manner similar to the FIG. 8A embodiment. In these embodiments, the front end of the access panel may drop about 3 inches to 5 inches from the closed to the open position.

As a further alternative, as shown in FIG. 9, the access panel could be embodied as a portion, or the entirety, of the bottom wall 40 of the enclosure 24. In this embodiment, the access panel could be connected to enclosure by telescopic posts 58 at the corners thereof, the posts being configured to allow lowering of the bottom panel 40 with respect to the rest of the enclosure 24, thereby providing access to the interior from the exterior thereof. The bottom wall could tilt from its orientation in the closed position as it is moved from the closed position to the open position and vice versa.

The access panel could be manually operated. Alternatively, a power operator and control system could be provided for opening and closing the access panel.

The enclosure 24 may include features enabling attachment of the enclosure to the vehicle or another structure. For example, as shown in FIGS. 2, 3, and 10, the side wall 24 of the enclosure 24 may be molded or otherwise formed to include pockets 60 to receive frame hangers (not shown) for attaching the enclosure 24 to the vehicle frame 36.

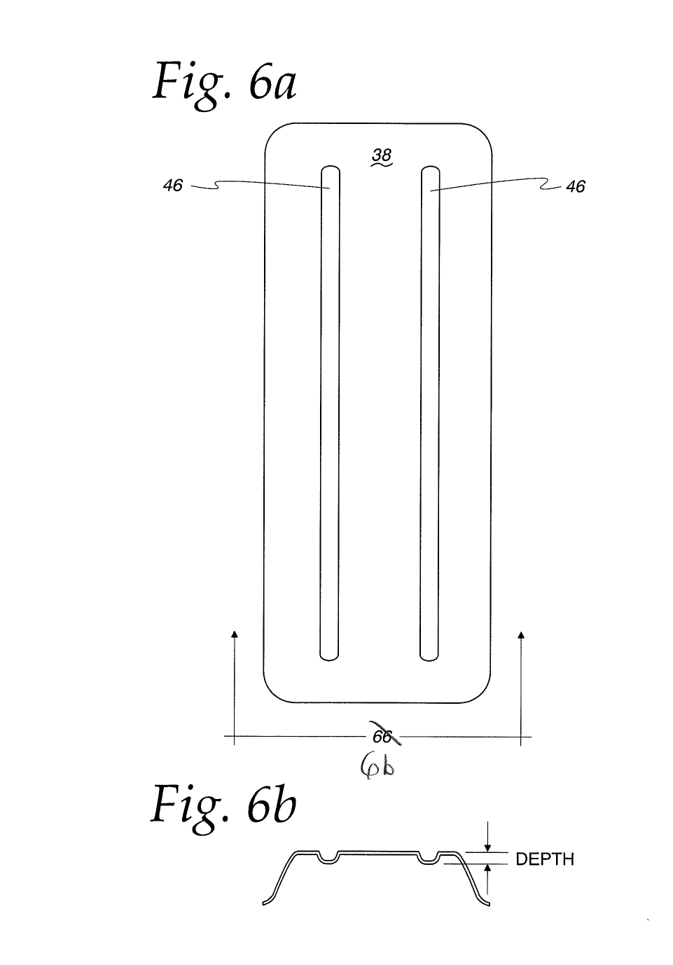

As suggested above, any wall of the enclosure 24 may include ribs, depressions, or the like for structural, functional, and/or decorative purposes. FIGS. 6A and 6B show depressions 62 formed into the top wall 38 of the enclosure and directed toward the interior of the enclosure. The depressions 62 may have a depth of about 0.25 inches or more or less. The depressions are shown as running from the front to the rear of the top wall 38, but could run left to right, obliquely, or in any other manner desired, over any desired length. These depressions may serve as stiffeners. They also may be decorative.

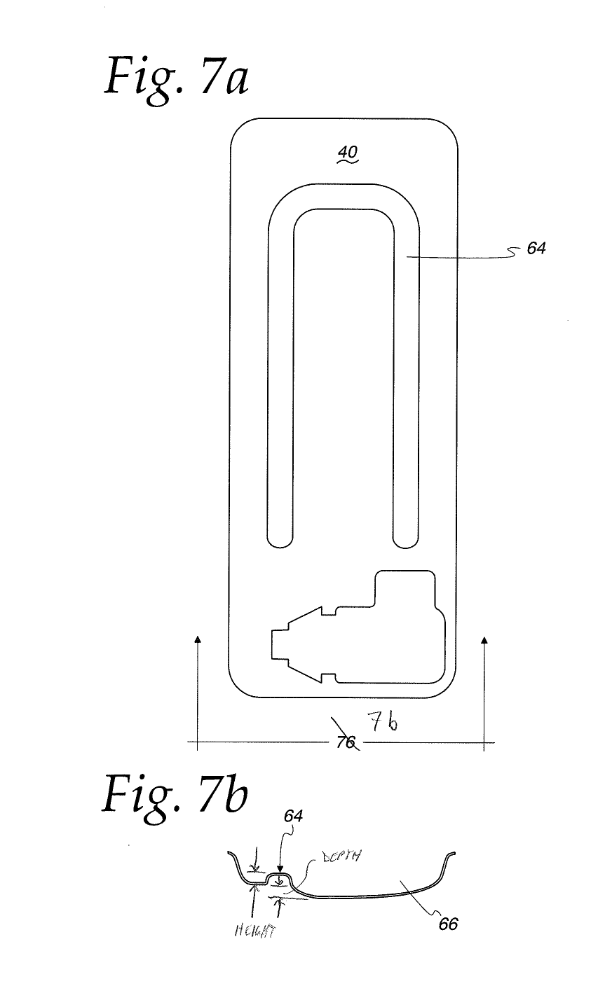

FIGS. 7A and 7B show the bottom or floor 40 of the enclosure 24 formed to include a locating rib 64 extending into the interior 44 of the enclosure. The locating rib 64 may be used to help locate the hose 26 along the side wall 42 of the enclosure 24 when the hose is stowed therein. The locating rib 64 may have a height of about 0.5 inches or more or less relative to the portion of the floor 40 between the locating rib and the side wall 42. Also, the locating rib 64 may have a width of about 1.5 inches or more or less. The locating rib 64 is shown as having a continuous U-shape, but could be configured in other manners or omitted. In other embodiments, the locating rib could be replaced by a depression in the bottom wall 40 of the enclosure 24 extending outwardly and configured to locate the hose 26 when the hose is stowed.

FIGS. 7A and 7B also show the floor 40 of the enclosure 24 formed to include a cradle 66 configured to locate the nozzle 28 when the nozzle is stowed within the enclosure. When provided, the cradle 66 may be shaped in a manner complementary to the nozzle 28, or it may simply be shaped as a depression sufficiently large to receive a corresponding portion of the nozzle. The nozzle tray is shown as having a depth of about 0.75 below adjacent portions of the floor and 1.25 inches below the top of the locating rib 66. In other embodiments, cradle 66 could be omitted and/or replaced by nubs formed into or extending from the bottom wall into the interior 44 of the enclosure 24 and configured to locate or otherwise provide a nest for the nozzle 28 when stowed.

In an alternative embodiment, the locating rib 64 and/or cradle 66 could be formed into a tray (not shown) that could be permanently or removably inserted into the interior 44 of the enclosure 24. The foregoing tray or floor 40 of the enclosure 24 upon which the hose 26 and the nozzle 28 may be stowed could be at an elevation above, below, or even with the waste water tank 30 outlet.

The enclosure 24 may be formed without the aperture 52, but configured to allow an installer to readily form the aperture 52. For example, the enclosure 52 may be formed with cut-out blanks 48 along the left and right side panels thereof, as shown in FIGS. 2 and 3. Cut-out blanks 48 may include a center point 49 in the form of a pilot hole or a divot for locating the pilot bit of a hole saw that could be used to remove a section of any desired cut-out blank 48 to form a corresponding aperture 52.

In an embodiment, the enclosure 24 could have interior or exterior dimensions of about 38″-48″ or more or less from the front wall to the back wall, about 8″-15″ or more or less from left side to right side, and about 4″ or more or less from top to bottom. These dimensions are provided for illustration. The enclosure 24 could be sized as necessary for a particular application and/or to receive a nozzle and/or a hose having a particular length, diameter and/or compressibility/compactability.

As shown in FIG. 10, the enclosure 24 may have a non-uniform height. For example, the height of the enclosure 24 may be greater proximate the front end panel 42A, particularly if the front end panel is embodied as an access panel. This feature may help to direct fluids or articles on the floor 40 of the enclosure 24 toward the front end panel 42A thereof, and help preclude the same from becoming trapped at the opposite end of the enclosure 24, which may not be readily accessible to a user. This feature also allows for storage of structure, for example, the nozzle 28, having a relatively great height proximate the access panel and storage of structure, for example, the hose 26, having a relatively small height, opposite the access panel. As such, this feature may allow for use of less material in the construction of the enclosure 24 than would be required if the enclosure's height were uniformly large to accommodate the largest structure to be stored therein.

The enclosure 24 could be made of any suitable material, for example, plastic, as shown in FIG. 2, metal, as shown in FIG. 3, wood, or combinations thereof.

The hose 26 may have a first (or upstream) end and a second (or downstream) end. The first end of the hose 26 may extend through the aperture 52 so that it can be connected to the waste water tank 30 outlet, either directly or by way of an intervening drain line 32 and/or isolation valve 34. The connection may be permanent, semi-permanent (that is, not removable without the use of tools), or by means of a quick-disconnect fitting, for example, a screwed fitting, a bayonet fitting or a cam-lock fitting 70. The first end of the hose may include a male or female fitting and the tank outlet or intervening drain line or isolation valve may include a complementary fitting to enable the connection. The hose/drain connection may be fully outside the enclosure 24. The foregoing hose connection may be made up at all times following initial installation of the system 20 onto the vehicle 22 unless the hose needs to be replaced. The hose connection also could be broken to enable splicing in a hose extension should an extension be required to enable connection of the system 20 to a ground sewer inlet.

The second end of the hose 26 may be connected to the nozzle 28. The connection of the nozzle 28 to the second end of the hose 26 may be permanent, semi-permanent, or by means of a quick-disconnect fitting. A rotating/swivel connector (not shown) may be provided between the nozzle 28 and the second end of the hose 26 to permit the nozzle to rotate with respect to the second end of hose.

In the illustrated embodiments, in the stowed position, a portion of the hose 26 between the first and second ends thereof enters the enclosure 24 through the aperture 52. The hose 26 then turns about 90 degrees toward an alignment about parallel with the side panel of the sidewall 42 of the enclosure 24 including the aperture 52, and generally toward the rear of the enclosure. The hose then turns about 180 degrees toward an alignment about parallel with the opposite side panel of the enclosure 24 and toward the front end of the enclosure. An anti-kink spring 72 or the like could be provided about the exterior of the hose 26 proximate the aperture 54 to help maintain the cross-section of the hose in an appropriate condition to preclude damage to the hose and to better enable flow there through.

A viewing port (not shown) may be provided between the hose 26 and the nozzle 28. Alternatively, the viewing port may be integrated with the hose 26 or the nozzle 28. The viewing port allows visual access to the interior thereof so that a user can see the effluent therein and its condition (solid, liquid, etc.).

A valve (not shown) may be associated with the nozzle. The valve may be upstream, preferably immediately upstream, of the nozzle, or it may be incorporated into the nozzle. A valve operator 68 may be provided to enable a user to operate the valve between open (enabling flow through the valve) or closed (disabling flow through the valve) positions. The valve operator 68 may be embodied as a handle 68 connected to the valve gate or plug or diaphragm, etc., or it could be a power operator, for example, a motor operator, a solenoid operator, an air operator, or another form of power operator.

In some embodiments, nozzle 28 could be replaced with a straight or angled fitting (for example, a 90 degree fitting) at the end of the hose 26, or it could be omitted. A cap could be provided to cover the open end of the nozzle, fitting, or second end of the hose.

The hose 26 may have a nominal diameter of about 3 inches or more or less. The hose 26 may be an extendable/collapsible hose having an extension ratio of about 4:1 or a greater or lesser ratio. The term “extension ratio” refers to the ratio of the hose's length when fully extended to the hose's length when fully collapsed. For example, a hose with a 4:1 extension ratio would have a fully extended length of four times its fully collapsed length. As a more specific example, a hose having a 4:1 extension ratio and a collapsed length of five (5) feet could be extended to a length of twenty (20) feet. Such a hose or a longer or shorter hose could be used in illustrative embodiments. The hose 24 may be a convoluted hose or other hose configured so that it remains in the extended position once it has been extended. Such a hose could be compacted or collapsed by a user grasping ends of sections thereof and compressing them together, one section at a time. Means could be provided to assist in the extension and collapsing of the hose. For example, pressurized air or a vacuum source could be selectively connected to the interior of the hose 24. With isolation valve 34 closed and the nozzle valve closed or an end cap, as discussed above, in place the pressurized air could cause the hose 26 to extend, and the vacuum could cause the hose to collapse.

The enclosure 24 could be mounted underneath the frame of the vehicle in a fixed or movable manner. For example, the frame of the vehicle could comprise one or more I-beams running fore and aft along the length of the vehicle. The enclosure could be fixedly mounted to the underside of the I-beams, either directly or using brackets or the like. The enclosure could be mounted such that the access panel is flush with or otherwise proximate the side wall of the vehicle. Alternatively, the enclosure 24 could be mounted with the access panel more remote from the sidewall of the vehicle, such that the access panel is less apparent to persons about the vehicle.

In an embodiment, the enclosure 24 could be mounted to a carrier slidably mounted to the underside of the vehicle frame or otherwise with respect to the vehicle frame so that access panel of the enclosure 24 could be selectively positioned near the side wall of the vehicle when the waste evacuation system 20 is in use, and so that the access panel and enclosure in general could be recessed from the side wall of the vehicle when the waste evacuation system is not in use. In such embodiments, the hose 26 could be sized and configured to accommodate the sliding of the enclosure 24 between stowed and extended positions. For example, if the carrier were to travel two feet between stowed and extended positions, the portion of the hose outboard of the enclosure (and strain relief, if provided) could be configured to extend two feet upon extension of the enclosure, and the hose could be, but need not be, configured to fully collapse upon return of the enclosure 24 to the stowed position.

In use, the access panel of the enclosure 24 may be unlatched and placed in the open position. (If the enclosure 24 is mounted on a slidable carrier, the slidable carrier may first be moved to a user-accessible position, preferably with the access panel near the side wall of the vehicle 22.) The nozzle 28 may then be withdrawn from the enclosure 24 and connected to the sewer inlet connection. The hose 26 may follow the nozzle 28 as the nozzle is moved to the sewer inlet connection. If the hose 26 is an extendable/collapsible hose, the hose may extend as the nozzle 28 is moved to the sewer inlet connection. The nozzle valve and the isolation valve 34 may be opened to initiate flow of effluent through the hose 26 and nozzle 28 and into the sewer inlet.

The isolation valve 34 and/or nozzle valve may be closed to stop the flow of effluent and/or isolate the system from the sewer inlet and/or environment at any time.

A cut-out (not shown) may be provided in the side wall 42 of the enclosure 24 configured to receive a cross section of the hose 26. This feature enables the user to close the access panel while the hose 26 is extended from the enclosure 24. This situation might arise, for example, if the user desires to leave the nozzle 28 connected to the sewer inlet for an extended period of time, yet not leave the access panel open.

The nozzle 28 may be moved back to the enclosure 24. The hose 26 may be moved into the enclosure 24. If the hose 26 is a compressible/collapsible hose, the hose may collapse without undue assistance by a user. The user may stow the hose 26 in the enclosure 24. In embodiments including the locating rib 64, the hose 26 may be stowed between the locating rib and the sidewall 42 of the enclosure. The user may stow the nozzle 28 in the enclosure 24. In embodiments including the cradle 66, the nozzle 28 may be stowed in/on the cradle 66. The access panel could then be closed and latched. If the enclosure is mounted on a slidable carrier, the carrier may be moved to a retracted position. As discussed above, the first end of the hose 24 may remain connected to the waste water tank 30 outlet at all times during storage and use of the system 20 and need be disconnected only in the event the hose needs to be replaced.

The embodiments disclosed herein are illustrative and should not be deemed to limit the scope of the invention as set forth in the appended claims.

1. A waste evacuation system for a vehicle, said vehicle having a frame, a driver side, and a waste water tank disposed on said vehicle, said waste evacuation system comprising:
a hose having an upstream end and a downstream end, said upstream end of said hose in fluid communication with said waste water tank;
a nozzle having an upstream end and a downstream end, said upstream end of said nozzle in fluid communication with said downstream end of said hose and said downstream end of said nozzle configured for removable attachment to a sewer inlet;
a nozzle valve incorporated into said nozzle; and
an enclosure attached to said vehicle, said nozzle and said downstream end of said hose removably contained within said enclosure.

2. The waste evacuation system of claim 1, said drain valve and said upstream end of said hose disposed outside said enclosure.

3. The waste evacuation system of claim 1, said enclosure comprising an access panel providing access to an interior portion of said enclosure from an exterior portion of said enclosure.

4. The waste evacuation system of claim 3, said access panel comprising an end of said enclosure.

5. The waste evacuation system of claim 3, said access panel comprising a bottom of said enclosure.

6. The waste evacuation system of claim 5, said access panel hinged to said enclosure.

7. The waste evacuation system of claim 5, said access panel removable from said enclosure.

8. The waste evacuation system of claim 1, said enclosure comprising a bottom portion defining surface contour configured to receive at least a portion of said hose or said nozzle.

9. The waste evacuation system of claim 8, said enclosure defining an aperture in a side panel of said enclosure, wherein said upstream end of said hose enters said enclosure through said aperture.

10. The waste evacuation system of claim 9, said hose comprising structural reinforcement proximate said aperture, said structural reinforcement configured to permit said hose to bend up to about 90 degrees relative to its orientation through said aperture without kinking.

11. The waste evacuation system of claim 1, said hose being extendable and collapsible and having an extended length and a collapsed length, said extended length being greater than said collapsed length.

12. The waste evacuation system of claim 1, said hose folding back upon itself when stowed within said enclosure.

13. The waste evacuation system of claim 3, said access panel comprising structure for receiving said nozzle.

14. The waste evacuation system of claim 1, said enclosure mounted below the frame of said vehicle.

15. The waste evacuation system of claim 14, the frame of said vehicle comprising a plurality of I-beams, said enclosure mounted below said I-beams.

16. The waste evacuation system of claim 1, said enclosure mounted aside the frame of said vehicle.

17. The waste evacuation system of claim 1, said enclosure mounted above the frame of said vehicle.

18. The waste evacuation system of claim 1, wherein said hose is at a higher elevation than said drain when said hose is stowed in said interior of said enclosure.

19. The waste evacuation system of claim

[symbol]

20. A method of using a waste evacuation system for a vehicle, comprising:
providing an enclosure defining an aperture in a wall thereof;
extending a hose having a first end and a second end through said aperture;
connecting said first end of said hose in fluid communication with a waste water tank disposed on a vehicle;
connecting said second end of said hose to a nozzle;
storing said nozzle and said second end of said hose in said enclosure with said first end of said hose extended through said aperture.
